(19) United States
(12) Patent Application Publication
(10) Pub. No.: US 2025/0331045 A1
(43) Pub. Date: Oct. 23, 2025

(54) TRANSMISSION TECHNIQUES FOR MULTI-AP TRANSMISSION

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US)

(73) Assignee: Ofinno, LLC, Reston, VA (US)

(21) Appl. No.: 19/181,409

(22) Filed: Apr. 17, 2025

Related U.S. Application Data
(63) Continuation of application No. PCT/US2023/035366, filed on Oct. 18, 2023.
(60) Provisional application No. 63/416,988, filed on Oct. 18, 2022.

(51) Int. Cl. H04W 76/15

(52) U.S. Cl. CPC H04W 76/15

(57) ABSTRACT

A first access point (AP) receives from a second AP a first frame comprising a multi-AP frequency channel assignment for a multi-AP transmission, the multi-AP frequency channel assignment comprising a first frequency channel allocated to the first AP for the multi-AP transmission. The first AP transmits a second frame on the first frequency channel during the multi-AP transmission, and, on condition that the first frequency channel is different from a primary channel of the first AP, transmits a portion of a preamble of the second frame, comprising the multi-AP frequency channel assignment, on the primary channel of the first AP.

### CROSS-REFERENCE TO RELATED APPLICATIONS

This application is a continuation of International Application No. PCT/US2023/035366, filed Oct. 18, 2023, which claims the benefit of U.S. Provisional Application No. 63/416,988, filed Oct. 18, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QoS) null frame which may be used to indicate buffer status information.

FIG. 5 illustrates an example multi-AP network.

FIG. 6 illustrates Enhanced Distributed Channel Access (EDCA) and Coordinated Orthogonal Frequency Division Multiple Access (COFDMA).

FIG. 7 illustrates an example procedure for setting up a multi-AP transmission.

FIG. 8 illustrates an example downlink multi-user physical layer (PHY) protocol data unit (DL MU PPDU) which may be used in an MU-MIMO transmission.

FIG. 9 illustrates example DL MU PPDUs which may be used in a COFDMA transmission.

FIG. 10 is an example that illustrates a problem that may arise in a multi-AP transmission setup using the procedure illustrated in FIG. 7.

FIG. 11 is an example that illustrates a PPDU reception problem that may arise in a multi-AP transmission setup using the procedure illustrated in FIG. 7.

FIG. 12 illustrates an example DL MU PPDU transmission according to an embodiment.

FIG. 13 illustrates an example signaling field which may be used in a DL MU PPDU transmission according to an embodiment.

FIG. 14 illustrates an example procedure which may be used to set up a multi-AP transmission according to an embodiment.

FIG. 15 illustrates an example procedure which may be used in combination with a multi-AP transmission procedure according to an embodiment.

FIG. 16 is an example that illustrates an example multi-AP transmission according to an embodiment.

FIG. 17 is an example that illustrates another example multi-AP transmission according to an embodiment.

FIG. 18 illustrates another example procedure which may be used to set up a multi-AP transmission according to an embodiment.

FIG. 19 illustrates an example process according to an embodiment.

FIG. 20 illustrates an example process according to an embodiment.

FIG. 21 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

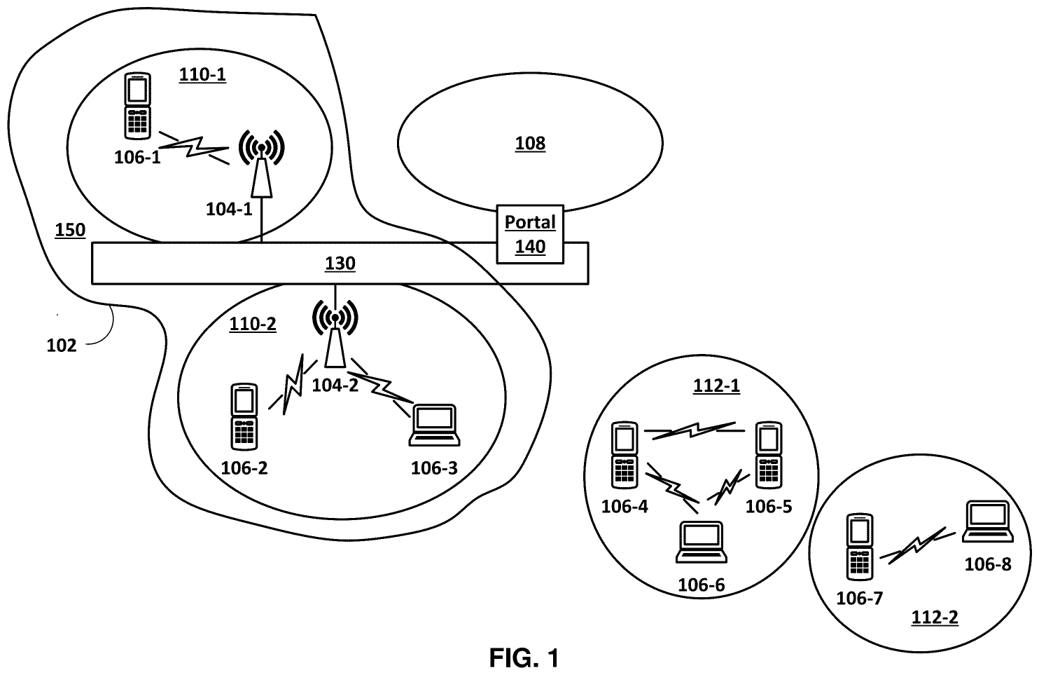

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHZ, 80 MHZ, 160 MHz, or 320 MHz by bonding together multiple 20 MHz channels.

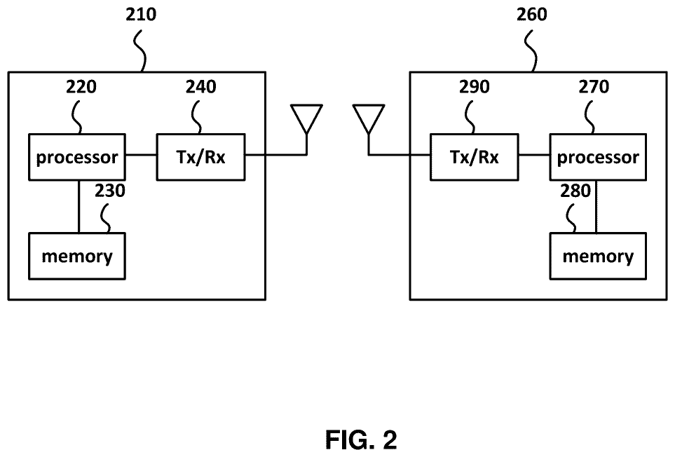

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, memory 280, and at least one transceiver 290. Processor 220/270 may be operatively connected to transceiver 240/290.

Transceiver 240/290 may be configured to transmit/receive radio signals. In an embodiment, transceiver 240/290 may implement a PHY layer of the corresponding device (STA 210 or AP 260).

In an embodiment, STA 210 and/or AP 260 may be a multi-link device (MLD), that is a device capable of operating over multiple links as defined by the IEEE 802.11be standard amendment. As such, STA 210 and/or AP 260 may each have multiple PHY layers. The multiple PHY layers may be implemented using one or more of transceivers 240/290.

Processor 220/270 may implement functions of the PHY layer, the MAC layer, and/or the logical link control (LLC) layer of the corresponding device (STA 210 or AP 260).

Processor 220/270 and/or transceiver 240/290 may include application specific integrated circuit (ASIC), other chipset, logic circuit and/or data processor. Memory 230/280 may include read-only memory (ROM), random access memory (RAM), flash memory, memory card, storage medium and/or other storage unit.

When the embodiments are executed by software, the techniques (or methods) described herein can be executed with modules (e.g., processes, functions, and so on) that perform the functions described herein. The modules can be stored in memory 230/280 and executed by processor 220/270. Memory 230/280 may be implemented (or positioned) within processor 220/270 or external to processor 220/270. Memory 230/280 may be operatively connected to processor 220/270 via various means known in the art.

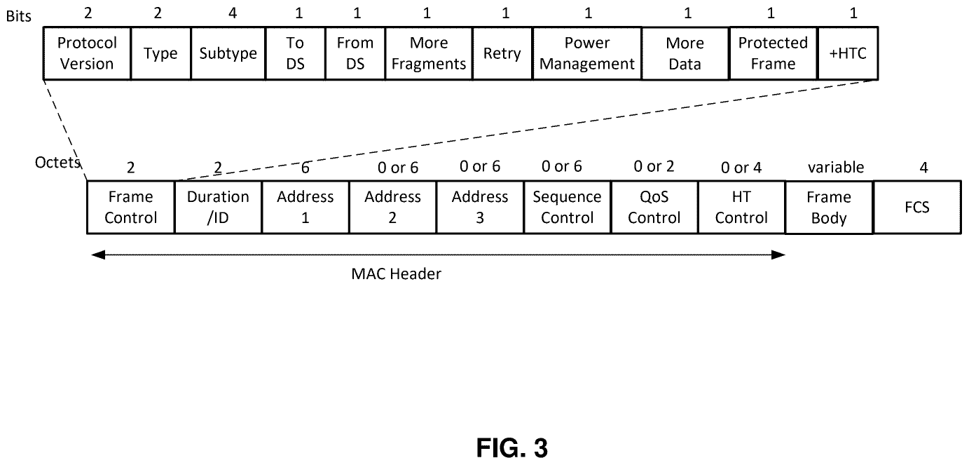

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, To DS, From DS, more fragments, retry, power management, more data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contain no frame body field.

The To DS subfield indicates whether a data frame is destined to the distribution system (DS). The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (Bus) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the MAC frame format. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

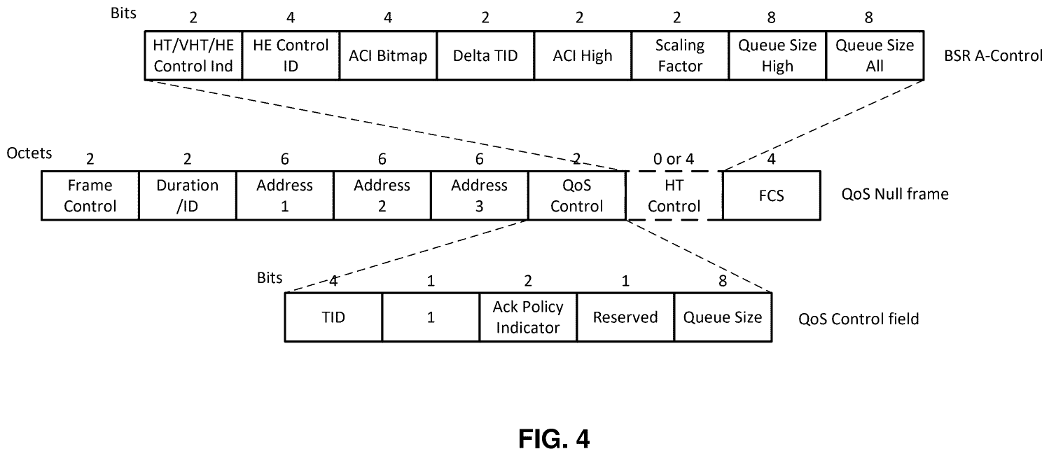

FIG. 4 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine the TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, on.

A STA obtains the queue size, QS, from a received QoS control field, which contains a scaling factor, SF, and an unscaled value, UV, as follows:
QS=
16×UV, if SF is equal to 0;
1024+256×UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

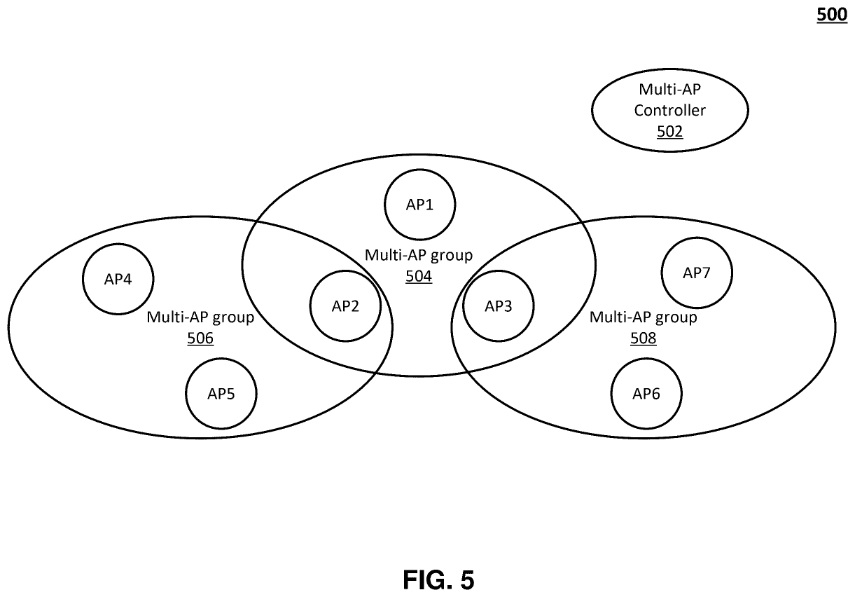

FIG. 5 illustrates an example multi-AP network 500. Example multi-AP network 500 may be a multi-AP network in accordance with the Wi-Fi Alliance standard specification for multi-AP networks. As shown in FIG. 5, multi-AP network 500 may include a multi-AP controller 502 and a plurality of multi-AP groups (or multi-AP sets) 504, 506, and 508.

Multi-AP controller 502 may be a logical entity that implements logic for controlling the APs in multi-AP network 500. Multi-AP controller 502 may receive capability information and measurements from the APs and may trigger AP control commands and operations on the APs. Multi-AP controller 502 may also provide onboarding functionality to onboard and provision APs onto multi-AP network 500.

Multi-AP groups 504, 506, and 508 may each include a plurality of APs. APs in a multi-AP group are in communication range of each other. However, the APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, one of the APs in a multi-AP group may be designated as a master AP. The designation of the master AP may be done by AP controller 502 or by the APs of the multi-AP group. The master AP of a multi-AP group may be fixed or may change over time between the APs of the multi-AP group. An AP that is not the master AP of the multi-AP group is known as a slave AP.

In one approach, APs in a multi-AP group may coordinate with each other, including coordinating transmissions within the multi-AP group. One aspect of coordination may include coordination to perform multi-AP transmissions within the multi-AP group. As used herein, a multi-AP transmission is a transmission event in which multiple APs (of a multi-AP group or a multi-AP network) transmit simultaneously over a time period. The time period of simultaneous AP transmission may be a continuous period. The multi-AP transmission may use different transmission techniques, such as Coordinated OFDMA, Coordinated Spatial Reuse, Joint Transmission and Reception, Coordinated Beamforming and Coordinated Time Division Multiple Access (TDMA), or a combination of two or more of the aforementioned techniques.

Multi-AP group coordination may be enabled by the AP controller and/or by the master AP of the multi-AP group. In one approach, the AP controller and/or the master AP may control time and/or frequency sharing in a TXOP. For example, when one of the APs (e.g., the master AP) in the multi-AP group obtains a TXOP, the AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

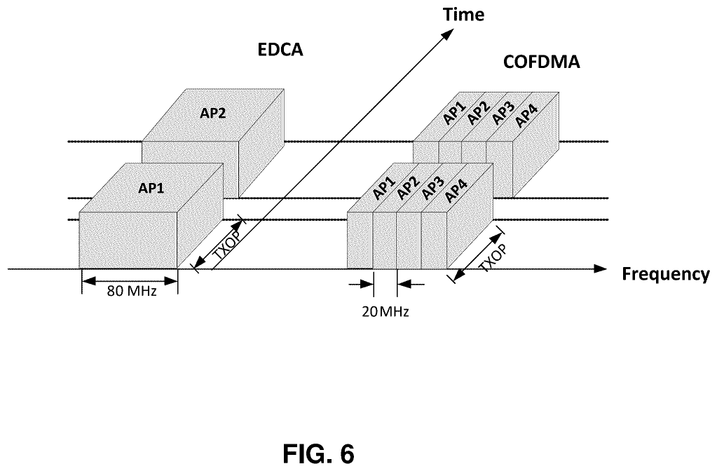

In coordinated OFDMA (COFDMA), the master AP may share a portion of its TXOP with multiple APs by assigning each of the multiple APs a respective frequency resource (e.g., channel/subchannel) of available frequency resources. COFDMA is illustrated in FIG. 6 as a multi-AP channel access, compared with Enhanced Distributed Channel Access (EDCA). As shown in FIG. 6, in EDCA, channel access by multiple APs (e.g., AP1, AP2) may occur in consecutive time periods (e.g., TXOPs). During a given channel access, the channel (e.g., 80 MHZ) in its entirety may be used by a single AP. In contrast, in COFDMA, access by multiple APs (multi-AP channel access) may take place in a same time period (e.g., same TXOP or same portion of a TXOP) over orthogonal frequency resources. For example, as shown in FIG. 6, an 80 MHz channel may be divided into four non-overlapping 20 MHz channels, each assigned to a respective AP of the multiple APs. The multiple APs may transmit in a coordinated manner, simultaneously in the same time period, to achieve a multi-AP transmission. In the multi-AP transmission, each of the multiple APs may transmit a PPDU to one or more STAs.

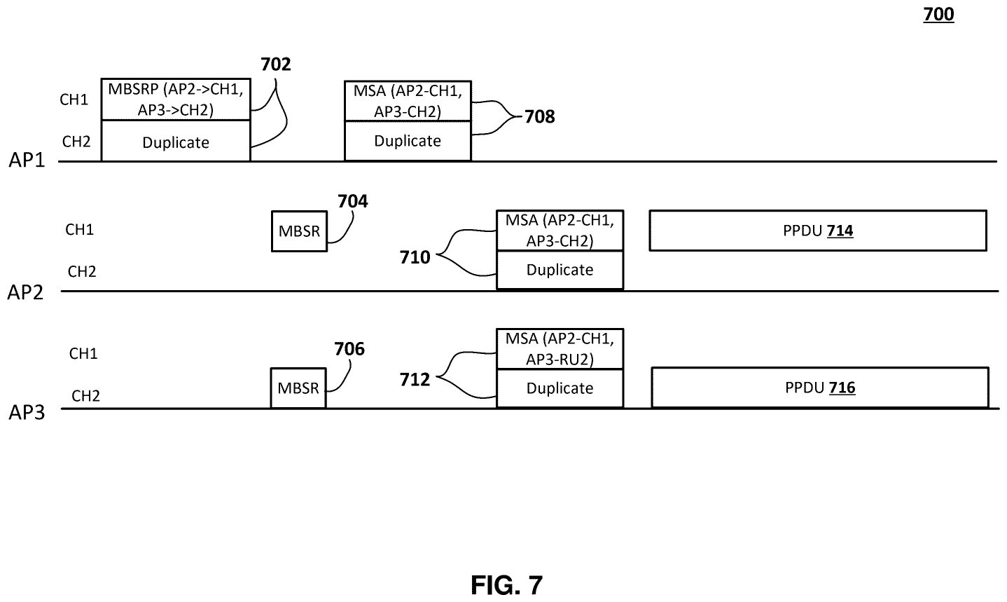

As described above, before a multi-AP transmission can be performed, time/frequency resources may need to be shared with (or allocated to) the participating APs. FIG. 7 illustrates an example 700 of a procedure which may be used to set up a multi-AP transmission, such as a COFDMA transmission. As shown in FIG. 7, example 700 includes a plurality of APs, AP1, AP2, and AP3. AP1, AP2, and AP3 may be part of a multi-AP group. Each of AP1, AP2, and AP3 may have one or more associated STAs (not shown in FIG. 7). For the purpose of illustration, it is assumed that the available frequency resources of the multi-AP group may be divided into a first frequency channel (CH1) and a second frequency channel (CH2). CH1 and CH2 may be non-overlapping channels. The primary channels of AP1, AP2, AP3 may be either CH1 or CH2.

In an example, AP1 may be the master AP of the multi-AP group comprising AP1, AP2, AP3. For example, AP1 may obtain a TXOP making it the master AP of the multi-AP group. Alternatively, AP1 may be designated as the master AP, manually by a human administrator (e.g., through a user interface of AP1) or by an AP controller. In an example, AP1 may decide that an upcoming TXOP shall be shared by multiple APs of the multi-AP group. The upcoming TXOP may be a TXOP obtained by AP1 or by another AP. For the purpose of illustration, it is assumed in example 700 that AP1 wishes to share an obtained TXOP with AP2 and AP3. By sharing the TXOP with AP2 and AP3, AP1 may allocate a portion of the TXOP to AP2 and AP3. AP2 and AP3 may perform a multi-AP transmission during the allocated portion of the TXOP. The multi-AP transmission may or may not include a transmission by AP1.

By the procedure shown in FIG. 7, AP1 may assign the available first and second frequency channels (CH1) and (CH2) to AP2 and AP3 for the allocated portion of the TXOP. As shown, AP1 may transmit a multi-AP Buffer Status Report Poll (MBSRP) frame 702 on both the first and second channels (CH1) and (CH2). MBSRP frame 702 polls receiving APs for buffer status for a multi-AP transmission during the allocated portion of the TXOP. An AP that wishes to participate in the planned multi-AP transmission responds to MBSRP frame 702 by transmitting a multi-AP buffer status report (MBSR) frame to AP1. The MBSR frame includes a buffer status report (BSR) for traffic intended to be transmitted by the AP during the multi-AP transmission. In example 700, AP2 and AP3 respond to MBSRP frame 702 by transmitting MBSR frames 704 and 706, respectively. MBSRP frame 702 may indicate the channels on which AP2 and AP3 shall respond to MBSRP frame 702. In example 700, AP2 may transmit MBSR frame 704 on the first channel (CH1), and AP3 may transmit MBSR frame 706 on the second channel (CH2).

On receiving MBSR frames 704 and 706, AP1 may determine an assignment of frequency channel to participating APs of the planned multi-AP transmission. In example 700, AP1 may assign the first channel (CH1) to AP2 and the second channel (CH2) to AP3. In making the channel assignment, AP1 may freely assign the channels to AP2 and AP3, without regard to the primary channels of AP2 and AP3. Subsequently, AP1 may transmit a multi-AP schedule announcement (MSA) frame 708 including the frequency channel assignment on both the first and second channels (CH1) and (CH2).

On receiving MSA frame 708, AP2 and AP3 broadcast the frequency channel assignment to their associated STAs by re-transmitting the frequency channel assignment in MSA frames 710 and 712, respectively. In order to prevent OBSS STAs surrounding AP2 and AP3 on both CH1 and CH2 from accessing the channel, AP2 and AP3 transmit MSA frames 710 and 712 respectively on both the first and second frequency channels (CH1) and (CH2).

Subsequently, AP2 and AP3 may proceed to participate in the multi-AP transmission during the allocated portion of the TXOP. In example 700, AP2 may transmit a PPDU 714 on the first channel (CH1). Simultaneously, AP3 may transmit a PPDU 716 on the second channel (CH2).

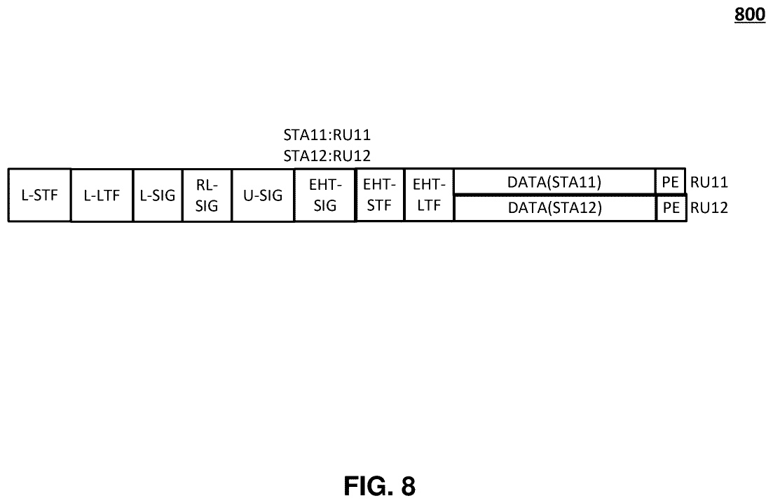

FIG. 8 illustrates an example downlink multi-user physical layer (PHY) protocol data unit (DL MU PPDU) 800. DL MU PPDU 800 may be used by an AP in an MU-MIMO transmission to multiple STAs, e.g., to STA11 and STA12 as shown in FIG. 8. In such an MU-MIMO transmission, the AP may use a plurality of transmit antennas to simultaneously transmit DL MU PPDU 800 to STA11 and STA12. In an example, DL MU PPDU 800 may be an Extremely High-Throughput (EHT) MU PPDU. DL MU PPDU 800 may thus be transmitted over a single 20 MHz channel.

When receiving DL MU PPDU 800, STA11 and STA12 may be configured to read and process one or more fields of a PHY preamble of DL MU PPDU 800. The PHY preamble of DL MU PPDU 800 may include a non-High Throughput (non-HT) Short Training field (L-STF), a non-HT Long Training field (L-LTF), a non-HT Signal field (L-SIG), a Repeated non-HT Signal field (RL-SIG), and a Universal Signal field (U-SIG). When DL MU PPDU 800 is an EHT MU PPDU as in FIG. 8, the PHY preamble of DL MU PPDU 800 may further include an EHT Signal field (EHT-SIG), an EHT Short Training field (EHT-STF), and an EHT Long Training field (EHT-LTF).

In an embodiment, STA11 and STA12 may be configured to read and process the PHY preamble of DL MU PPDU 800 over the entire bandwidth (e.g., 20 MHZ) of DL MU PPDU 800 until reaching the EHT-SIG. From the EHT-SIG, STA11 and STA12 each retrieves a respective resource unit (RU) allocation (e.g., RU11 for STA11 and RU12 for STA12) for the remainder of DL MU PPDU 800. In an example, the bandwidth (e.g., 20 MHZ) of DL MU PPDU 800 may be shared equally between STA11 and STA12.

Subsequently, STA11 and STA12 may each read and process the remainder of DL MU PPDU 800 over only those subcarriers corresponding to its respective allocated RU. Specifically, STA11 and STA12 may read and process the EHT-STF and the EHT-LTF of the PHY preamble of DL MU PPDU 800 over the subcarriers corresponding to RU11 and RU12 respectively. Based on reading and processing the EHT-STF and the EHT-LTF, STA11 and STA12 may perform a channel estimation of respectively the subcarriers corresponding to RU11 and RU12. STA11 and STA12 may then each read and process a respective Data field, and optionally a respective Packet Extension (PE) field, from DL MU PPDU 800 over the subcarriers corresponding to its allocated RU.

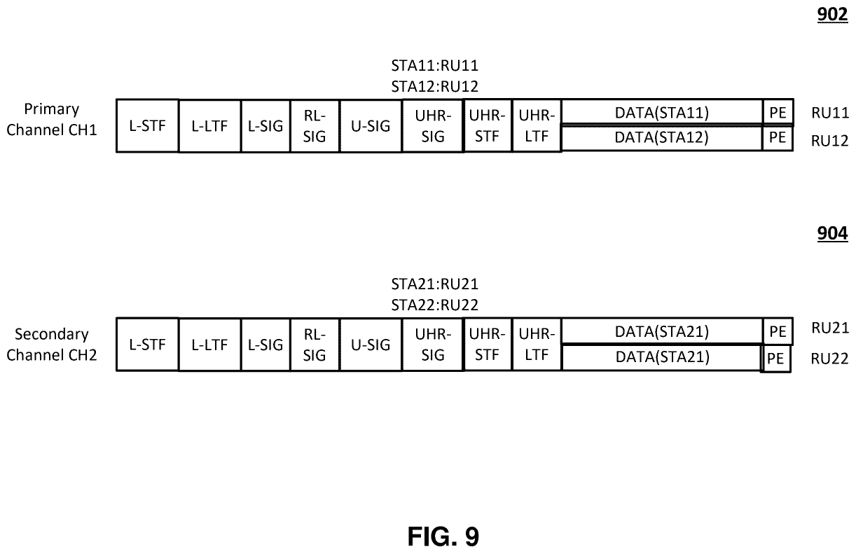

FIG. 9 illustrates example DL MU PPDUs 902 and 904 which may be used in an example COFDMA transmission. In such an example COFDMA transmission, DL MU PPDUs 902 and 904 may be transmitted simultaneously over respective orthogonal frequency channels (e.g., a first frequency channel, CH1, and a second frequency channel, CH2). Specifically, DL MU PPDU 902 may be transmitted by a first AP, e.g., AP1, to two associated STAs, STA11 and STA12, and DL MU PPDU 904 may be transmitted by a second AP, e.g., AP2, to two associated STAs, STA21 and STA22. For example, DL MU PPDU 902 and 904 may correspond to PPDUs 714 and 716 described above with reference to FIG. 7. In an example, DL MU PPDUs 902 and 904 may be Ultra High Reliability (UHR) MU PPDUs.

In an example, AP1 and AP2 may both have the first frequency channel, CH1, as a primary channel. AP1 and AP2 may receive a frequency channel assignment for the COFDMA transmission assigning CH1 to AP1 and CH2 to AP2. AP1 and AP2 may broadcast the frequency channel assignment to their associated STAs on both CH1 and CH2. Based on AP2 being assigned CH2, STA21 and STA22, associated with AP2, may switch from the primary channel (CH1) of AP2 to CH2. AP1 and AP2 may then transmit MU PPDUs 902 and 904 respectively on CH1 and CH2.

Like example DL MU PPDU 800 described above, DL MU PPDUs 902 and 904 may each include a PHY preamble, including an L-STF, an L-LTF, an L-SIG, an RL-SIG, and a U-SIG. In an example, DL MU PPDUs 902 and 904 may be UHR MU PPDUs. The PHY preamble may thus further include a UHR Signal field (UHR-SIG), a UHR Short Training field (UHR-STF), and a UHR Long Training field (UHR-LTF).

In an embodiment, STA11 and STA12 may be configured to read and process the PHY preamble of DL MU PPDU 902 over the entire bandwidth (e.g., 20 MHZ) of CH1 until reaching the UHR-SIG. From the UHR-SIG, STA11 and STA12 each retrieves a respective resource unit (RU) allocation (e.g., RU11 for STA11 and RU12 for STA12) for the remainder of DL MU PPDU 902. In an example, the bandwidth (e.g., 20 MHZ) of CH1 may be shared equally between STA11 and STA12. Subsequently, STA11 and STA12 may each read and process the remainder of DL MU PPDU 902 over only those subcarriers corresponding to its respective allocated RU. Specifically, STA11 and STA12 may read and process the UHR-STF and the UHR-LTF of the PHY preamble over the subcarriers corresponding to RU11 and RU12 respectively. Based on reading and processing the UHR-STF and the UHR-LTF, STA11 and STA12 may perform a channel estimation of respectively the subcarriers corresponding to RU11 and RU12. STA11 and STA12 may then each read and process a respective Data field, and optionally a respective Packet Extension (PE) field, from DL MU PPDU 902 over the subcarriers corresponding to its allocated RU.

The reception of MU PPDU 904 by STA21 and STA22 is similar to the reception of MU PPDU 902 by STA11 and STA21. For the sake of conciseness, this description is omitted herein.

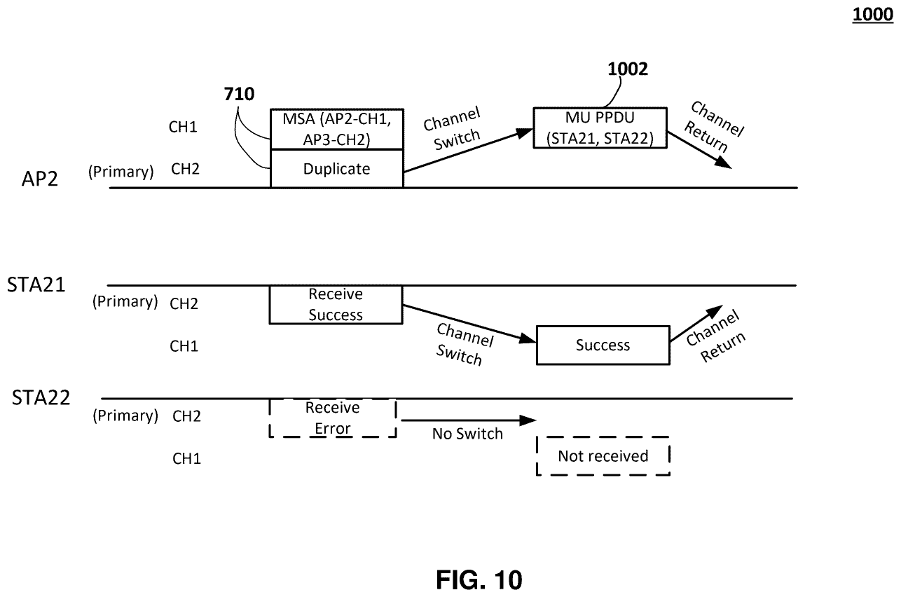

FIG. 10 is an example 1000 that illustrates a problem that may arise in a multi-AP transmission setup using the procedure illustrated in FIG. 7. Example 1000 may follow example 700 described above after AP2 transmits MSA frame 710 on the first and second frequency channels (CH1) and (CH2) to its associated STAs. As shown in FIG. 10, for the purpose of illustration, it is assumed in example 1000 that AP2 uses the second channel (CH2) as a primary channel. It is further assumed that AP2 has two associated STAs, STA21 and STA22. Upon association with AP2, STA21 and STA22 also use the second channel (CH2) as a primary channel.

In example 1000, AP2 may switch from its primary channel (CH2) to the first channel (CH1) allocated in MSA frame 708 after transmitting MSA frame 710. STA21, operating on the second channel (CH2), successfully receives MSA frame 710. STA21 reads the frequency channel assignment contained in MSA frame 710 and, based on AP2 being assigned the first channel (CH1) in the frequency channel assignment, switches its operating channel from its primary channel (CH2) to the first channel (CH1). In contrast, STA22, also operating on the second channel (CH2), fails to receive or receives MSA frame 710 in error. The unsuccessful/erroneous reception of MSA frame 710 by STA22 may be due to high interference, for example. Accordingly, STA22 performs no switching of operating channel and continues to operate on its primary channel (CH2).

Not knowing that STA22 did not switch to the second channel (CH2), AP2 proceeds to transmit an MU PPDU 1002 to STAs 21 and STA22 on the first channel (CH1). MU PPDU 1002 may include a respective MPDU or Aggregate MPDU (AMPDU) for each of STA21 and STA22. MU PPDU 1002 may be similar to DL MU PPDU 904 described above in FIG. 9. MU PPDU 1002 may be part of a multi-AP transmission in the multi-AP group (AP1, AP2, AP3) shown in FIG. 7. AP2 may return to its primary channel (CH2) after transmitting MU PPDU 1002.

Having switched to the first channel (CH1), STA21 successfully receives MU PPDU 1002 and is able to decode its respective MPDU or AMPDU contained in MU PPDU 1002. STA21 may return to its primary channel (CH2) after receiving MU PPDU 1002. In contrast, STA22 fails to receive MU PPDU 1002 having remained on the second channel (CH2) due to its failure to receive MSA frame 710.

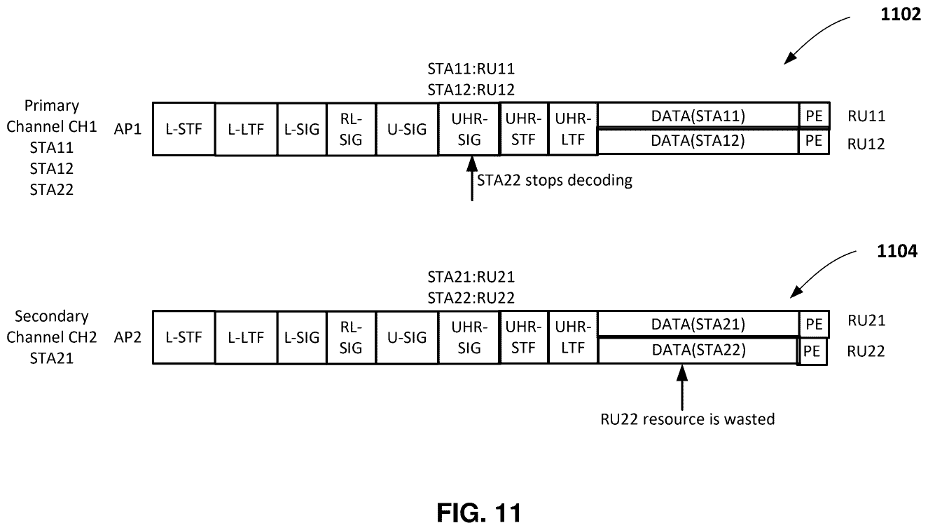

FIG. 11 is an example that illustrates a PPDU reception problem that may arise in a multi-AP transmission setup using the procedure illustrated in FIG. 7. As shown in FIG. 11, the multi-AP transmission may include a first AP, AP1, and a second AP, AP2, simultaneously transmitting respectively MU PPDUs 1102 and 1104. Prior to the multi-AP transmission, AP1 and AP2 may receive a multi-AP frequency channel assignment for the multi-AP transmission. In an example, both AP1 and AP2 have a first frequency channel, CH1, as a primary channel. The frequency channel assignment may assign CH1 to AP1 and a second frequency channel, CH2, to AP2. CH2 may be a secondary channel for AP1 and AP2. AP1 and AP2 may broadcast the frequency channel assignment to their associated STAs on both CH1 and CH2.

In an example, as illustrated in FIG. 10 above, STA21, associated with AP2, successfully receives on CH1 the frequency channel assignment broadcast by AP2. Based on AP2 being assigned CH2 for the multi-AP transmission, STA21 switches its operating channel from its primary channel (CH1) to CH2. In contrast, STA22, also associated with AP2, fails to receive or receives the frequency channel assignment in error. Accordingly, STA22 performs no switching of operating channel and continues to operate on its primary channel (CH1). STA11 and STA12, associated with AP1, may continue to operate on CH1, the primary channel of AP1. This may be irrespective of whether STA11 and STA12 successfully receive the frequency channel assignment.

After broadcasting the frequency channel assignment, AP1 transmits MU PPDU 1102 to STA11 and STA12 on CH1. STA11 and STA12 successfully receive MU PPDU 1102 as both STAs operate on CH1. STA11 and STA12 each decodes MU PPDU 1102 to retrieve a respective allocated RU in the UHR-SIG (e.g., RU11 for STA11 and RU12 for STA12). STA11 and STA12 may then each read and process a respective Data field, and optionally a respective Packet Extension (PE) field, from MU PPDU 1102 over the subcarriers corresponding to its allocated RU.

After broadcasting the frequency channel assignment, AP2 switches from CH1 to CH2. Not knowing that STA22 did not switch to CH2, AP2 transmits MU PPDU 1104 to STA21 and STA22 on CH2. Having switched to CH2, STA21 successfully receives MU PPDU 1104. STA21 decodes MU PPDU 1104 to retrieve a respective allocated RU in the UHR-SIG (e.g., RU21). STA21 may then read and process a respective Data field, and optionally a respective Packet Extension (PE) field, from MU PPDU 1104 over the subcarriers corresponding to its allocated RU. In contrast, having remained on CH1, STA22 fails to receive MU PPDU 1104. STA22 may receive MU PPDU 1102 from AP1 on CH1. STA22 may read and process one or more fields (e.g., L-STF, L-LTF, L-SIG, RL-SIG, and U-SIG) of a PHY preamble of MU PPDU 1102. On reaching the UHR-SIG of MU PPDU 1102, STA22 discovers that the UHR-SIG does not include an RU for it (e.g., STA22 fails to locate its AID in the UHR-SIG). Based on this determination, STA22 stops decoding MU PPDU 1102. As STA22 remains on CH1 afterwards, STA22 fails to receive data intended for it in MU PPDU 1104 and the RU dedicated to STA22 (e.g., RU22) in MU PPDU 1104 is lost.

As highlighted in the example of FIGS. 10 and 11 above, existing procedures for setting up a multi-AP transmission may result in situations of unsuccessful communication between a participating AP of the multi-AP transmission and one or more associated STAs. Such situations not only cause resources shared for the multi-AP transmission to be lost but also may cause the QoS requirements of certain traffic types to be missed in the multi-AP group. Traffic types that may be particularly impacted include traffic types in which a PPDU contains one or more payloads intended for multiple users, such as broadcast traffic (single data payload intended for all users), multicast traffic (single data payload intended for multiple users), or multi-user unicast traffic (multiple payloads each intended to a respective user). Embodiments described below mitigate the above-described problems of the existing procedures.

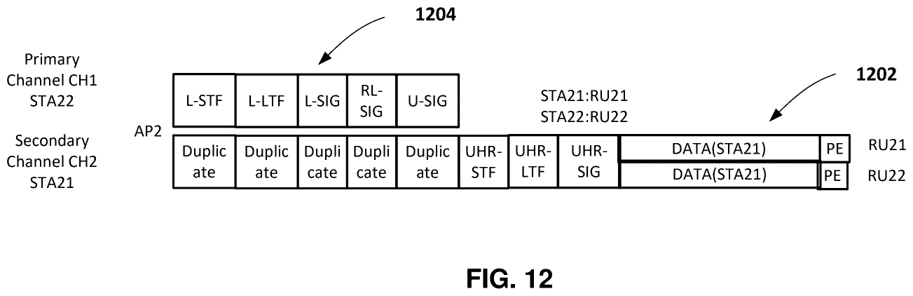

FIG. 12 illustrates an example DL MU PPDU transmission according to an embodiment. The example DL MU PPDU transmission may be performed by an AP in a multi-AP transmission. For the purpose of illustration, the example DL MU PPDU transmission is described with reference to AP2 described in the example of FIG. 11 above. As described earlier, AP2 may receive a multi-AP frequency channel assignment for a multi-AP transmission (including AP1). AP2 may have a first frequency channel (CH1) as a primary channel.

In an embodiment, the example DL MU PPDU transmission includes AP2 transmitting an MU PPDU 1202 on CH2 during the multi-AP transmission. MU PPDU 1202 may be intended for STA21 and STA22 associated with AP2.

In an example, the multi-AP frequency channel assignment assigns AP2 a second frequency channel (CH2) for the multi-AP transmission. In an embodiment, on condition that CH2 is different from the primary channel CH1 of AP2, the DL MU PPDU transmission may further include transmitting a portion 1204 of a preamble of MU PPDU 1202 on the primary channel CH1 during the multi-AP transmission. The portion 1204 transmitted on CH1 duplicates a corresponding portion of MU PPDU 1202 transmitted on CH2. The portion 1204 of the preamble of MU PPDU 1202 may include the multi-AP frequency channel assignment.

In an embodiment, the portion 1204 of the preamble of MU PPDU 1202 may be transmitted in parallel with transmitting MU PPDU 1202 (the transmission of the portion 1204 of the preamble coincides in time with the transmission of a portion of MU PPDU 1202). In another embodiment, the portion 1204 of the preamble of MU PPDU 1202 may be transmitted synchronously with transmitting MU PPDU 1202. That is, as shown in FIG. 12, the transmission of the portion 1204 of the preamble of MU PPDU 1202 transmitted on the primary channel CH1 may be synchronized with the transmission of a corresponding duplicate portion of MU PPDU 1202 transmitted on CH2.

In an embodiment, the portion 1204 of the preamble of MU PPDU 1202 transmitted on the primary channel CH1 includes a U-SIG. In an embodiment, the portion 1204 of the preamble of MU PPDU 1202 transmitted on the primary channel CH1 includes an L-STF, an L-LTF, an L-SIG, an RL-SIG, and a U-SIG. In an embodiment, the U-SIG includes the multi-AP frequency channel assignment for the multi-AP transmission. That is, the U-SIG indicates that AP2 is assigned CH2 for the multi-AP transmission.

In an embodiment, as shown in FIG. 12, MU PPDU 1202 further comprises a UHR-STF, a UHR-LTF, and a UHR-SIG. The UHR-STF and the UHR-LTF may be part of the preamble of MU PPDU 1202. In an embodiment, the UHR-STF and/or the UHR-LTF precede the UHR-SIG. In an embodiment, the UHR-SIG indicates respective RUs for STA21 and STA22 for which MU PPDU 1202 is intended.

For the purpose of illustration, the reception of the DL MU PPDU transmission by STA21 and STA22 associated with AP2 is described. As described earlier, it is assumed in this example that STA21 successfully receives on CH1 the frequency channel assignment broadcast by AP2. Based on AP2 being assigned CH2 for the multi-AP transmission, STA21 switches its operating channel from its primary channel (CH1) to CH2. In contrast, STA22 fails to receive or receives the frequency channel assignment in error. Accordingly, STA22 performs no switching of operating channel and continues to operate on its primary channel (CH1).

In accordance with this example, STA21 successfully receives MU PPDU 1202 on CH2. STA21 decodes the UHR-SIG of MU PPDU 1202 to locate a respective allocated RU (e.g., RU21). Then, STA21 reads and processes a respective Data field, and optionally a respective PE field, from DL MU PPDU 1202 over the subcarriers corresponding to its allocated RU. STA22 successfully receives the portion 1204 of the preamble of MU PPDU 1202 on CH1. In an embodiment, STA22 decodes the U-SIG of the portion 1204 to retrieve the multi-AP frequency channel assignment for the multi-AP transmission. The multi-AP frequency channel assignment indicates that AP2 is assigned CH2 for the multi-AP transmission. As such, STA22 switches from CH1 to CH2 after receiving the U-SIG on CH1. STA22 then begins to receive DL MU PPDU 1202 on CH2 and, particularly, receives the UHR-STF and the UHR-LTF of DL MU PPDU 1202. Based on the UHR-STF and the UHR-LTF, STA22 may perform a channel estimation of CH2 from AP2 to STA22. STA22 then receives the UHR-SIG of MU PPDU 1202. In an embodiment, STA22 receives the UHR-SIG using the channel estimation of CH2. This is possible according to embodiments based on having the UHR-STF and/or the UHR-LTF precede the UHR-SIG in MU PPDU 1202 (in contrast to PPDUs 902 and 904 in which UHR-SIG precedes UHR-STF and UHR-LTF). From the UHR-SIG, STA22 locates a respective allocated RU (e.g., RU22). Then, STA22 reads and processes a respective Data field, and optionally a respective PE field, from DL MU PPDU 1202 over the subcarriers corresponding to its allocated RU.

Thus, by duplicating the portion 1204 of the preamble of MU PPDU 1202 on its primary channel (CH1), AP2 allows STA22 which remained on CH1 to switch to the appropriate channel (CH2) for the multi-AP transmission.

It is noted that in a multi-AP transmission including AP1 and AP2, it may be possible for STA22 which remained on CH1 to receive the DL PPDU transmitted by AP1 on CH1. STA22 may thus read the U-SIG of the DL PPDU from AP1. In an embodiment, where the multi-AP frequency channel assignment is included in the U-SIG of the DL PPDU from AP1, STA22 may switch from CH1 to CH2 based on reading the U-SIG of the DL PPDU from AP1. In such an embodiment, the transmission of the portion 1204 of the preamble of MU PPDU 1202 on CH1 by AP2 may be omitted. However, in another embodiment, while STA22 is still on CH1, STA22 may use the portion 1204 of the preamble to perform time and power synchronization with AP2. AP2 may thus be better synchronized with AP2 when it switches from CH1 to CH2, facilitating the reception of subsequent fields of MU PPDU 1202 (e.g., UHR-STF, UHR-LTF, and UHR-SIG). This advantage may not be present in the absence of the portion 1204 of the preamble being transmitted by AP2 on CH1.

As would be understood by a person of skill in the art based on the teachings, the above-described DL MU PPDU transmission technique may be readily extended to single-user (SU) PPDU transmission. In such embodiments, an AP may transmit an SU PPDU on a first frequency channel and a duplicate of a portion of the preamble of the SU PPDU on a second frequency channel. The first frequency channel may be a channel assigned to the AP for a multi-AP transmission; and the second frequency channel may be a primary channel of the AP, or vice versa.

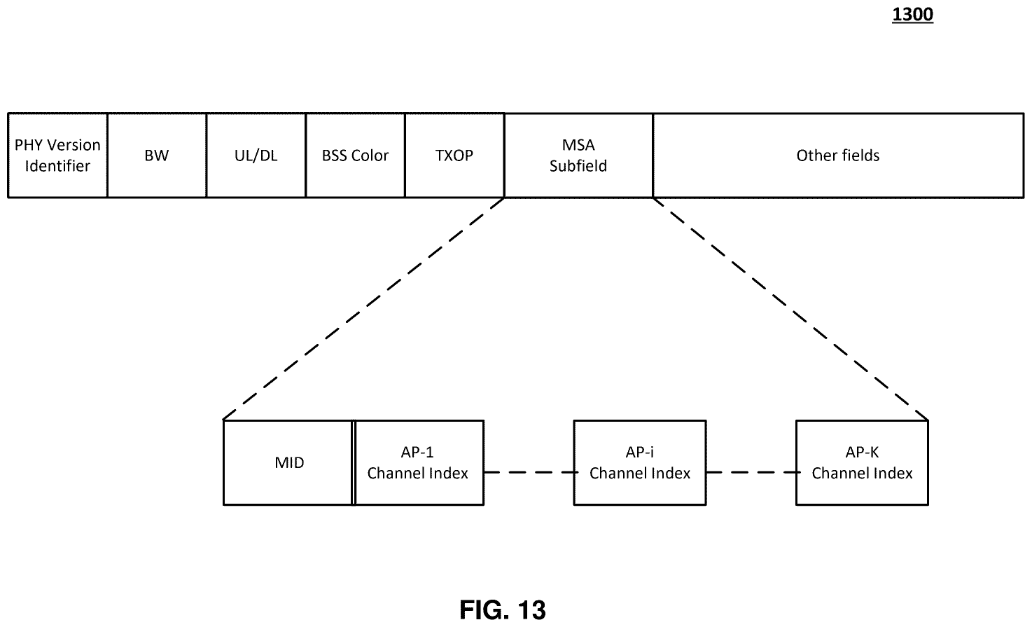

FIG. 13 illustrates an example signaling field 1300 which may be used in a DL PPDU (e.g. DL MU PPDU or DL SU PPDU) transmission according to an embodiment. As described above, the DL PPDU transmission may include the transmission of a DL PPDU on a first frequency channel in parallel with the transmission of a portion of a preamble of the DL PPDU on a second frequency channel. In an embodiment, example signaling field 1300 may be provided in a U-SIG of the DL PPDU and/or the portion of the preamble of the DL PPDU.

As shown in FIG. 13, example signaling field 1300 may include, among other subfields, a PHY Version Identifier, a bandwidth subfield (BW), an UL/DL subfield, a BSS Color subfield, a TXOP subfield, and a multi-AP schedule announcement (MSA) subfield.

In an embodiment, the DL PPDU transmission may occur in a multi-AP transmission. The MSA subfield may include a multi-AP frequency channel assignment for the multi-AP transmission.

In an embodiment, the MSA subfield may include a multi-AP identifier (MID) subfield indicating a multi-AP group of the AP performing the DL PPDU transmission. Specifically, the MID subfield indicates the multi-AP group (of which the AP is a member) for which the multi-AP transmission is being performed. It is noted herein that an AP may be a member of more than one multi-AP group. Each multi-AP group may have a respective identifier.

In an embodiment, the MSA subfield may a plurality of AP channel subfields. The plurality of AP channel subfields each indicates a frequency channel assigned to a respective AP for the multi-AP transmission. In an embodiment, each of the plurality of AP channel subfields is associated with an index, e.g., based on its position within the MSA subfield.

In an embodiment, a first AP channel subfield of the plurality of AP channel subfields of the MSA subfield indicates a first frequency channel allocated to the AP performing the DL PPDU transmission. To locate the first frequency channel allocated to the AP, an associated STA uses an index associated with the AP for the multi-AP group indicated by the MID subfield. For example, the STA may be configured such that for an MID subfield equal to 1 (corresponding to a first multi-AP group of the AP), the index associated with the AP is equal to 2. The STA locates the first frequency channel in the AP channel subfield with the same index (e.g., the AP channel subfield in the second position in the MSA subfield). In an embodiment, <MID, AP index> tuples of AP may be signaled to associated STAs during the association procedure.

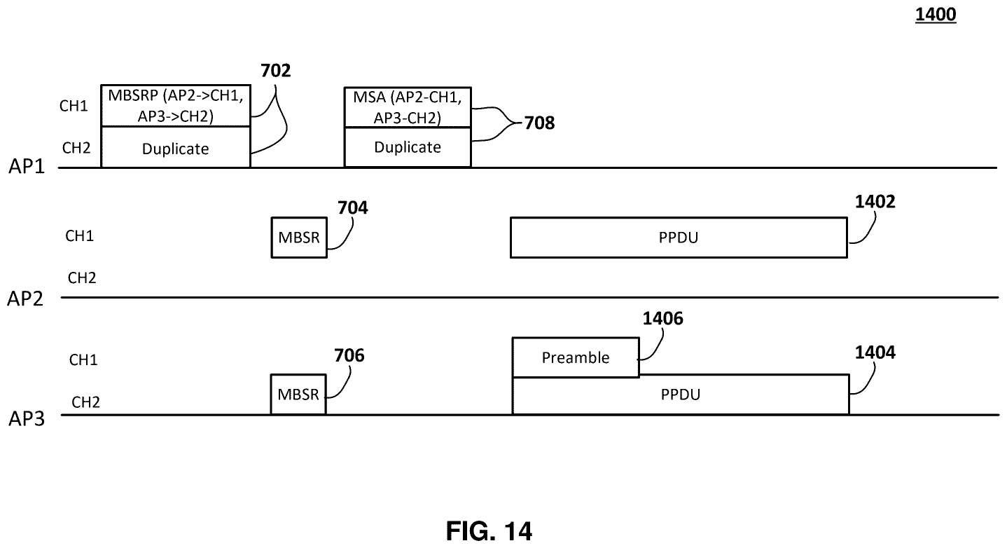

FIG. 14 illustrates an example procedure 1400 which may be used to set up a multi-AP transmission according to an embodiment. As in example 700 described above, example 1400 includes a plurality of APs, AP1, AP2, and AP3. AP1, AP2, and AP3 may be part of a multi-AP group. Each of AP1, AP2, and AP3 may have one or more associated STAs (not shown in FIG. 14). For the purpose of illustration, it is assumed that the available frequency resources of the multi-AP group may be divided into a first frequency channel (CH1) and a second frequency channel (CH2). CH1 and CH2 may be non-overlapping channels. For the purpose of illustration, it is assumed that AP2 and AP3 both have CH1 as a primary channel.

In an example, AP1 may be the master AP of the multi-AP group comprising AP1, AP2, AP3. For example, AP1 may obtain a TXOP making it the master AP of the multi-AP group. Alternatively, AP1 may be designated as the master AP, manually by a human administrator (e.g., through a user interface of AP1) or by an AP controller. In an example, AP1 may decide that an upcoming TXOP shall be shared by multiple APs of the multi-AP group. The upcoming TXOP may be a TXOP obtained by AP1 or by another AP. For the purpose of illustration, it is assumed in example 1400 that AP1 wishes to share an obtained TXOP with AP2 and AP3. By sharing the TXOP with AP2 and AP3, AP1 may allocate a portion of the TXOP to AP2 and AP3. AP2 and AP3 may perform a multi-AP transmission during the allocated portion of the TXOP. The multi-AP transmission may or may not include a transmission by AP1.

As in example 700 described above, AP1 may transmit a MBSRP frame 702 on both the first and second channels (CH1) and (CH2). MBSRP frame 702 polls receiving APs for buffer status for a multi-AP transmission during the allocated portion of the TXOP. An AP that wishes to participate in the planned multi-AP transmission responds to MBSRP frame 702 by transmitting a MBSR frame to AP1. The MBSR frame includes a BSR for traffic intended to be transmitted by the AP during the multi-AP transmission. In example 1400, AP2 and AP3 respond to MBSRP frame 702 by transmitting MBSR frames 704 and 706, respectively. MBSRP frame 702 may indicate the channels on which AP2 and AP3 shall respond to MBSRP frame 702. In example 1400, AP2 may transmit MBSR frame 704 on the first channel (CH1), and AP3 may transmit MBSR frame 706 on the second channel (CH2).

On receiving MBSR frames 704 and 706, AP1 may determine an assignment of frequency channel to participating APs of the planned multi-AP transmission. In example 1400, AP1 may assign the first channel (CH1) to AP2 and the second channel (CH2) to AP3. In making the channel assignment, AP1 may freely assign the channels to AP2 and AP3, without regard to the primary channels of AP2 and AP3. Subsequently, AP1 may transmit an MSA frame 708 including the frequency channel assignment on both the first and second channels (CH1) and (CH2).

In an embodiment, the multi-AP transmission by AP2 and AP3 may occur immediately after AP2 and AP3 receive MSA frame 708. That is, AP2 and AP3 may omit broadcasting the multi-AP frequency assignment in MSA frames as in FIG. 7. Specifically, having been assigned its primary channel CH1 for the multi-AP transmission, AP2 transmits a PPDU 1402 on CH1. PPDU 1402 may be an SU PPDU or a MU PPDU. AP2 does not transmit on CH2 during the multi-AP transmission. In contrast, being assigned channel CH2 which is different than its primary channel CH1, AP3 may perform a DL PPDU transmission in accordance with an embodiment of the present disclosure, e.g., as described above with reference to FIG. 12. Specifically, AP3 transmits a PPDU 1404 on its assigned channel CH2 and a portion 1406 of a preamble of PPDU 1404 on its primary channel CH1. PPDU 1404 may be an SU PPDU or an MU PPDU.

In accordance with the above-described embodiments, an intended STA of PPDU 1404 may successfully receive PPDU 1404 regardless of whether the STA switched to CH2 assigned to AP3 for the multi-AP transmission. In an embodiment, this feature of the present disclosure allows the broadcast of the frequency channel assignment, at least by AP2, to be omitted. This reduces the overhead necessary to setup the multi-AP transmission.

In another embodiment (not shown in FIGS. 14), AP2 and AP3 may still broadcast the frequency channel assignment to their associated STAs by re-transmitting the frequency channel assignment in MSA frames as in FIG. 7 before participating in the multi-AP transmission.

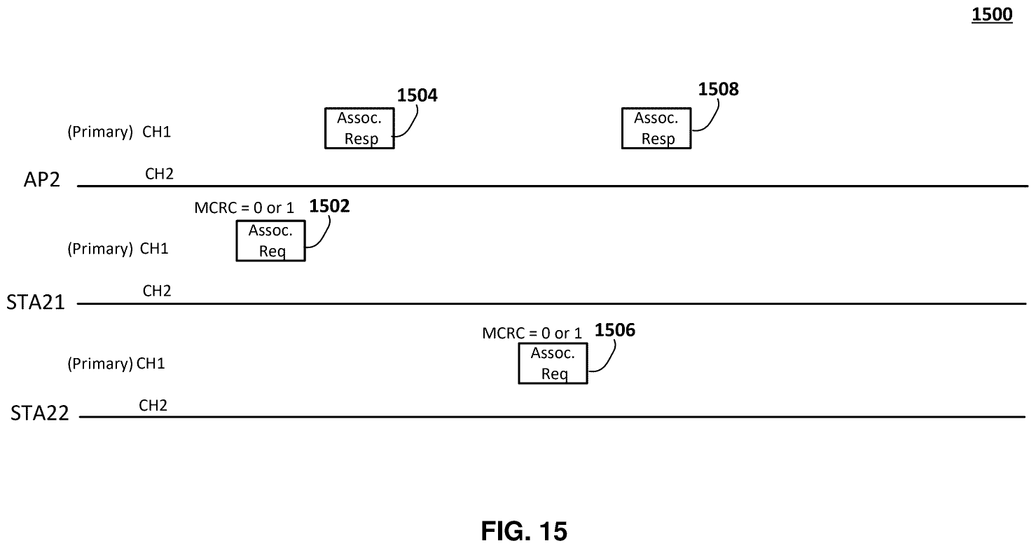

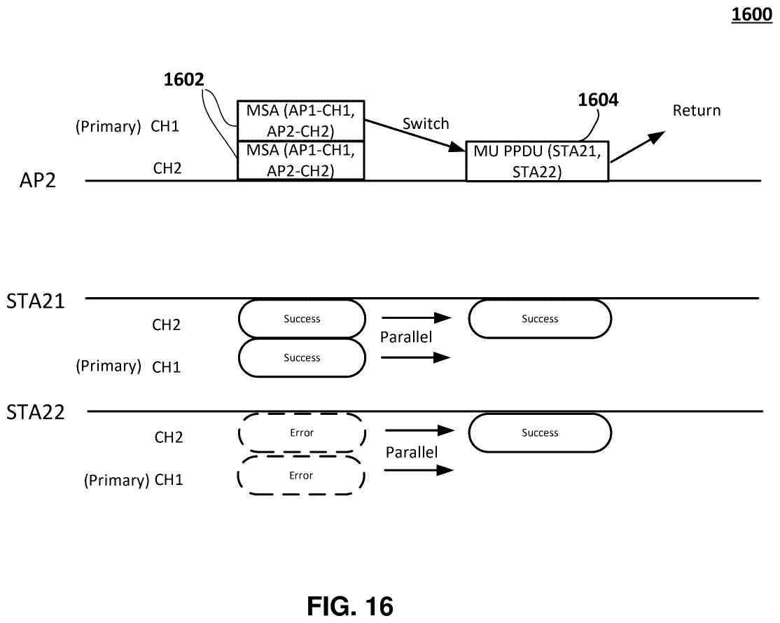

FIG. 15 illustrates an example procedure 1500 which may be used in combination with a multi-AP transmission procedure according to an embodiment. As further described below with reference to FIGS. 16, 17, and 18, example procedure 1500 may be used in combination with a multi-AP transmission according to embodiments to mitigate the above-described problems of the existing procedures for setting up a multi-AP transmission. For the purpose of illustration only, procedure 1500 is described with reference to an example including an AP, AP2, and two STAs, STA21 and STA22. AP2 may correspond, for example, to AP2 described in example 700. AP2 may be a part of a multi-AP group including one or more other APs. It is assumed that AP2 has a first frequency channel (CH1) as a primary channel. AP2 may have a second frequency channel (CH2) as a secondary channel.

As shown in FIG. 15, example procedure 1500 may include STA21 transmitting an association request 1502 to AP2. STA21 may transmit association request 1502 on CH1 after receiving a beacon frame (not shown) from AP2 on CH1. In an embodiment, association request 1502 indicates whether STA21 supports a multi-channel receive capability (MCRC) according to which STA21 is capable of receiving on multiple frequency channels simultaneously. AP2 responds to association request 1502 with an association response 1504 confirming the association of STA21 with AP2.

In a similar manner, STA22 may transmit an association request 1506 on CH1 after receiving a beacon frame (not shown) from AP2 on CH1. In an embodiment, association request 1506 indicates whether STA22 supports MCRC. AP2 responds to association request 1506 with an association response 1508 confirming the association of STA22 with AP2.

FIG. 16 is an example 1600 that illustrates a multi-AP transmission according to an embodiment. As shown in FIG. 16, example 1600 includes an AP, AP2, and two STAs, STA21 and STA22. AP2 may correspond, for example, to AP2 described in example 700. AP2 may be a part of a multi-AP group including another AP, AP1. For the purpose of illustration, it is assumed that AP2 has a first frequency channel (CH1) as a primary channel. AP2 may have a second frequency channel (CH2) as a secondary channel.

In an embodiment, STA21 and STA22 are associated with AP2 using example procedure 1500 described above. As such, AP2 has knowledge of the MCRC support of STA21 and STA22. In example 1600, it is assumed that both STA21 and STA22 support MCRC on CH1 and CH2.

Example 1600 begins with AP2 broadcasting an MSA frame 1602 on CH1 and CH2. MSA frame 1602 includes a multi-AP frequency channel assignment for a multi-AP transmission including AP1 and AP2. AP2 may receive the multi-AP frequency channel assignment from another AP, e.g., a master AP. In example 1600, it is assumed that AP1 is assigned CH1 and that AP2 is assigned CH2 in the multi-AP frequency channel assignment.

In an embodiment, when AP2 is assigned a frequency channel different than its primary channel (CH1), and on condition that a candidate STA for the multi-AP transmission supports MCRC, AP2 may include data frames for the candidate STA in an SU PPDU or a MU PPDU transmitted during the multi-AP transmission. In an embodiment, AP2 does not confirm whether the candidate STAs received the frequency channel assignment and/or switched to the frequency channel assigned to AP2 for the multi-AP transmission. Specifically, in example 1600, AP2 does not need to confirm that STA21 or STA22 received MSA frame 1602 and switched to CH2 to receive MU PPDU 1604. Instead, AP2 determines to transmit MU PPDU 1604 based on its knowledge that STA21 and STA22 both support MCRC and are able to receive on CH2 as well as on the primary channel CH1.

In example 1600, it is assumed, for the purpose of illustration, that STA21 successfully receives MSA frame 1602 on both CH1 and CH2, while STA22 fails to receive MSA frame 1602 on both CH1 and CH2. However, as both STA21 and STA22 support MCRC, both STAs can successfully receive MU PPDU 1604 on CH2. In other words, the knowledge of the multi-AP frequency assignment by an intended STA of the MU PPDU is not necessary when the STA supports MCRC. Accordingly, in an embodiment, the broadcast of MSA frame 1602 may be omitted by AP2, further simplifying the setup procedure for the multi-AP transmission.

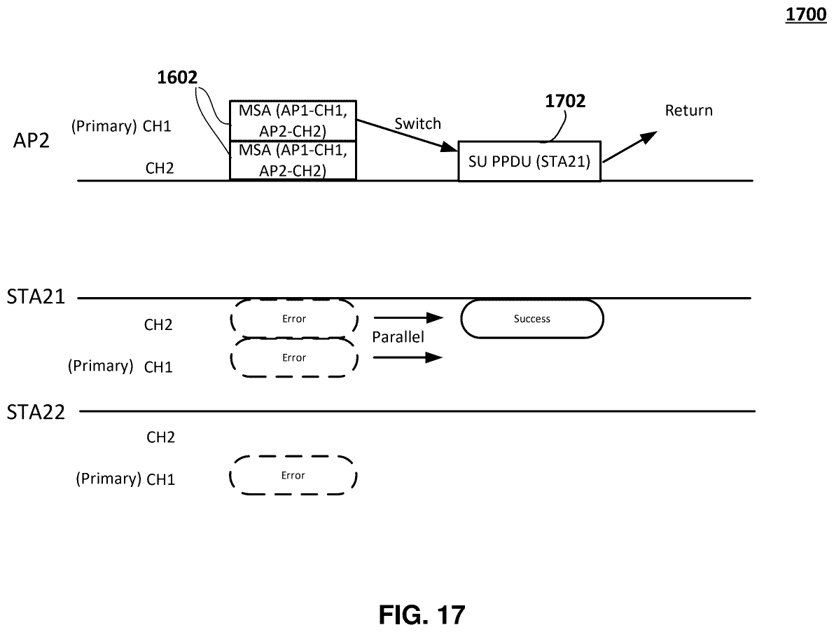

FIG. 17 is an example 1700 that illustrates another multi-AP transmission according to an embodiment. Like example 1600 described above, example 1700 also includes an AP, AP2, and two STAs, STA21 and STA22. AP2 may correspond, for example, to AP2 described in example 700. AP2 may be a part of a multi-AP group including another AP, AP1. For the purpose of illustration, it is assumed that AP2 has a first frequency channel (CH1) as a primary channel. AP2 may have a second frequency channel (CH2) as a secondary channel.

In an embodiment, STA21 and STA22 are associated with AP2 using example procedure 1500 described above. As such, AP2 has knowledge of the MCRC support of STA21 and STA22. In example 1700, it is assumed that STA21supports MCRC on CH1 and CH2 while STA22 does not support MCRC.

Like example 1600, example 1700 begins with AP2 broadcasting MSA frame 1602 on CH1 and CH2. MSA frame 1602 includes a multi-AP frequency channel assignment for a multi-AP transmission including AP1 and AP2. In example 1700, it is assumed that AP1 is assigned CH1 and that AP2 is assigned CH2 in the multi-AP frequency channel assignment.

In an embodiment, when AP2 is assigned a frequency channel different than its primary channel (CH1), and if a candidate STA for the multi-AP transmission does not support MCRC, AP2 may transmit an SU PPDU to the remaining candidate STA for the multi-AP transmission. In an embodiment, AP2 does not confirm whether the remaining candidate STA received the frequency channel assignment and/or switched to the frequency channel assigned to AP2 for the multi-AP transmission. Specifically, in example 1700, AP2 does not need to confirm that STA21 received MSA frame 1602 and switched to CH2. Instead, AP2 determines to transmit SU PPDU 1702 based on its knowledge that STA21 supports MCRC and is able to receive on CH2 as well as on the primary channel CH1.

In example 1700, it is assumed, for the purpose of illustration, that STA21 fails to receive MSA frame 1602 on both CH1 and CH2 and that STA22 fails to receive MSA frame 1602 on CH1. However, as STA21 supports MCRC, STA21 can successfully receive SU PPDU 1702 on CH2. Accordingly, in an embodiment, the broadcast of MSA frame 1602 may be omitted by AP2, further simplifying the setup procedure for the multi-AP transmission.

As illustrated by examples 1600 and 1700, an AP assigned a frequency channel different than its primary channel for the multi-AP transmission may adapt its PPDU transmission for multi-AP transmission based on the MCRC support of candidate STAs for the multi-AP transmission. Examples 1600 and 1700 describe cases in which there are only two candidate STAs (STA21 and STA22) for the multi-AP transmission. As would be understood by a person of skill in the art based on the teachings herein, the same techniques may be applied in transmission scenarios including more than two candidate STAs. For example, in the case of 3 candidate STAs, if at least two candidate STAs support MCRC, the AP may transmit an MU PPDU to the candidate STAs supporting MCRC. If only one candidate STA supports MCRC, the AP may transmit an SU PPDU to that candidate STA.

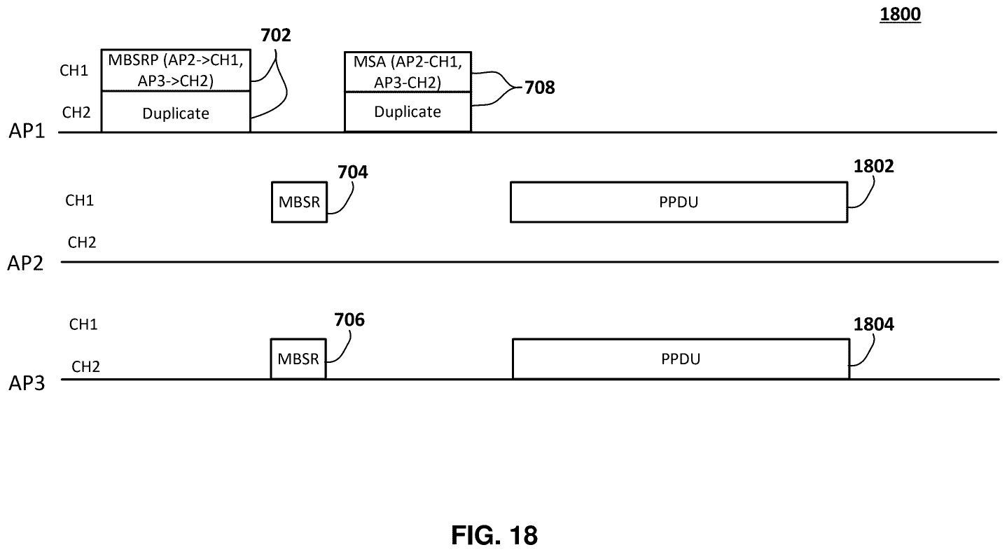

FIG. 18 illustrates another example procedure 1800 which may be used to set up a multi-AP transmission according to an embodiment. As in example 700 described above, example 1800 includes a plurality of APs, AP1, AP2, and AP3. AP1, AP2, and AP3 may be part of a multi-AP group. Each of AP1, AP2, and AP3 may have one or more associated STAs (not shown in FIG. 18). For the purpose of illustration, it is assumed that the available frequency resources of the multi-AP group may be divided into a first frequency channel (CH1) and a second frequency channel (CH2). CH1 and CH2 may be non-overlapping channels. For the purpose of illustration, it is assumed that AP2 and AP3 both have CH1 as a primary channel.

In an embodiment, STAs are associated with AP1, AP2, and AP3 using example procedure 1500 described above. As such, each of AP1, AP2, and AP3 has knowledge of the MCRC support of their associated STAs.

In an example, AP1 may be the master AP of the multi-AP group comprising AP1, AP2, AP3. For example, AP1 may obtain a TXOP making it the master AP of the multi-AP group. Alternatively, AP1 may be designated as the master AP, manually by a human administrator (e.g., through a user interface of AP1) or by an AP controller. In an example, AP1 may decide that an upcoming TXOP shall be shared by multiple APs of the multi-AP group. The upcoming TXOP may be a TXOP obtained by AP1 or by another AP. For the purpose of illustration, it is assumed in example 1800 that AP1 wishes to share an obtained TXOP with AP2 and AP3. By sharing the TXOP with AP2 and AP3, AP1 may allocate a portion of the TXOP to AP2 and AP3. AP2 and AP3 may perform a multi-AP transmission during the allocated portion of the TXOP. The multi-AP transmission may or may not include a transmission by AP1.

As in example 700 described above, AP1 may transmit a MBSRP frame 702 on both the first and second channels (CH1) and (CH2). MBSRP frame 702 polls receiving APs for buffer status for a multi-AP transmission during the allocated portion of the TXOP. An AP that wishes to participate in the planned multi-AP transmission responds to MBSRP frame 702 by transmitting a MBSR frame to AP1. The MBSR frame includes a BSR for traffic intended to be transmitted by the AP during the multi-AP transmission. In example 1800, AP2 and AP3 respond to MBSRP frame 702 by transmitting MBSR frames 704 and 706, respectively. MBSRP frame 702 may indicate the channels on which AP2 and AP3 shall respond to MBSRP frame 702. In example 1800, AP2 may transmit MBSR frame 704 on the first channel (CH1), and AP3 may transmit MBSR frame 706 on the second channel (CH2).

On receiving MBSR frames 704 and 706, AP1 may determine an assignment of frequency channel to participating APs of the planned multi-AP transmission. In example 1800, AP1 may assign the first channel (CH1) to AP2 and the second channel (CH2) to AP3. In making the channel assignment, AP1 may freely assign the channels to AP2 and AP3, without regard to the primary channels of AP2 and AP3. Subsequently, AP1 may transmit an MSA frame 708 including the frequency channel assignment on both the first and second channels (CH1) and (CH2).

In an embodiment, the multi-AP transmission by AP2 and AP3 may occur immediately after AP2 and AP3 receive MSA frame 708. That is, AP2 and AP3 may omit broadcasting the multi-AP frequency assignment in MSA frames as in FIG. 7. Specifically, having been assigned its primary channel CH1 for the multi-AP transmission, AP2 transmits a PPDU 1802 on CH1. PPDU 1802 may be an SU PPDU or a MU PPDU. In an embodiment, based on AP2 being assigned its primary channel for the multi-AP transmission, AP2 may opt to transmit an SU PPDU or an MU PPDU as PPDU 1802, without regard to the MCRC capabilities of candidate STAs for the multi-AP transmission. For example, AP2 may transmit an MU PPDU as PPDU 1802 to associated STAs, STA21 and STA22. Each of STA21 and STA22 may or may not support MCRC.

In contrast, being assigned channel CH2 which is different than its primary channel CH1, AP3 may perform a DL PPDU transmission in accordance with an embodiment of the present disclosure, e.g., as described above with reference to FIGS. 16 and 17 above. Specifically, in an embodiment, on condition that candidate STAs for the multi-AP transmission all support MCRC, AP3 may opt to transmit an MU PPDU as PPDU 1804 to the candidate STAs for the multi-AP transmission. In an embodiment, AP3 does not confirm whether the candidate STAs received the frequency channel assignment and/or switched to the frequency channel assigned to AP3 for the multi-AP transmission. AP3 also need not transmit a portion of the preamble of the MU PPDU on CH1. Instead, AP3 determines to transmit an MU PPDU as PPDU 1804 based on its knowledge that all candidate STAs for the multi-AP transmission support MCRC and are able to receive on CH2 as well as on the primary channel CH1. On the other hand, if a candidate STA for the multi-AP transmission does not support MCRC, AP3 may opt to transmit an SU PPDU as PPDU 1804 to the remaining candidate STA for the multi-AP transmission. In an embodiment, AP3 does not confirm whether the remaining candidate STA received the frequency channel assignment and/or switched to the frequency channel assigned to AP3 for the multi-AP transmission. Instead, AP3 determines to transmit an SU PPDU as PPDU 1804 based on its knowledge that the remaining candidate STA supports MCRC and is able to receive on CH2 as well as on the primary channel CH1.

In another embodiment (not shown in FIG. 18), AP2 and/or AP3 may still broadcast the frequency channel assignment to their associated STAs by re-transmitting the frequency channel assignment in MSA frames as in FIG. 7 before participating in the multi-AP transmission. In an embodiment, AP2 and/or AP3 may broadcast the frequency channel assignment on condition that none of the candidate STAs for the multi-AP transmission support MCRC.

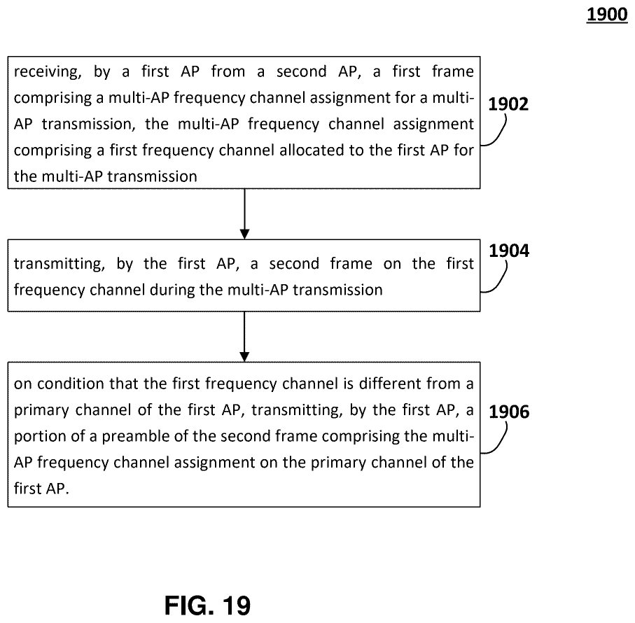

FIG. 19 illustrates an example process 1900 according to an embodiment. Example process 1900 is provided for the purpose of illustration only and is not limiting of embodiments. Process 1900 may be performed by a first AP. The first AP may be a member of a multi-AP group.

As shown in FIG. 19, process 1900 begins in step 1902, which includes receiving, by the first AP from a second AP, a first frame comprising a multi-AP frequency channel assignment for a multi-AP transmission. The multi-AP frequency channel assignment includes a first frequency channel allocated to the first AP for the multi-AP transmission. In an embodiment, the second AP may be a master AP of the multi-AP group. In an embodiment, the multi-AP transmission occurs during a transmit opportunity (TXOP) obtained by the second AP. The multi-AP transmission may be a COFDMA transmission, for example, including the first AP and a third AP, member of the multi-AP group. In an embodiment, the first frame comprises a multi-AP schedule announcement (MSA) frame.

In an embodiment, prior to step 1902, process 1900 may further include receiving, by the first AP from the second AP, a frame polling the first AP for buffered traffic for the multi-AP transmission. The frame may be a MBSRP frame. In an embodiment, prior to step 1902, process 1900 may further include transmitting, by the first AP to the second AP, a frame comprising a BSR for the multi-AP transmission. In an embodiment, the BSR for the multi-AP transmission indicates a TID for traffic having a non-empty queue size at the first AP and that the first AP wishes to transmit during the multi-AP transmission. In an embodiment, the frame comprising the BSR may be an MBSR frame.

In an embodiment, after step 1902, process 1900 may include broadcasting, by the first AP, the first frame to one or more associated stations (STAs).

In step 1904, process 1900 includes transmitting, by the first AP, a second frame on the first frequency channel during the multi-AP transmission. The second frame may include a PPDU. The PPDU may be an SU PPDU or an MU PPDU.

In step 1906, process 1900 includes transmitting, by the first AP, a portion of a preamble of the second frame comprising the multi-AP frequency channel assignment on a primary channel of the first AP, on condition that the first frequency channel is different from the primary channel of the first AP. In an embodiment, the primary channel of the first AP corresponds to a default channel that the first AP monitors for management frames. In an embodiment, the primary channel of the first AP corresponds to a default channel that the first AP uses to transmit beacon frames.

In an embodiment, step 1906 is performed concurrently with step 1904. As such, in an embodiment, transmitting the portion of the preamble of the second frame comprises transmitting the portion of the preamble of the second frame in parallel with transmitting the second frame (the transmission of the portion of the preamble coincides in time with the transmission of a portion of the second frame). In another embodiment, transmitting the portion of the preamble of the second frame comprises transmitting the portion of the preamble of the second frame synchronously with transmitting the second frame (the transmission of the portion of the preamble is synchronized in time with the transmission of a corresponding portion of the second frame).

In an embodiment, where the second frame is a PPDU, the portion of the preamble of the second frame comprises a portion of a preamble of a PPDU. In an embodiment, the portion of the preamble of the PPDU comprises a Universal Signal field (U-SIG). In an embodiment, the portion of the preamble of the PPDU comprises: a non-High Throughput (non-HT) Short Training field (L-STF), a non-HT Long Training field (L-LTF), a non-HT Signal field (L-SIG), a Repeated non-HT Signal field (RL-SIG), and a Universal Signal field (U-SIG).

In an embodiment, the U-SIG comprises the multi-AP frequency channel assignment for the multi-AP transmission. In an embodiment, the U-SIG comprises a multi-AP schedule announcement (MSA) subfield comprising the multi-AP frequency channel assignment for the multi-AP transmission. In an embodiment, the MSA subfield comprises a multi-AP identifier (MID) subfield indicating a multi-AP group of the first AP. In an embodiment, the MSA subfield further comprises a first AP channel subfield indicating the first frequency channel allocated to the first AP for the multi-AP transmission. In an embodiment, the MSA subfield comprises a plurality of AP channel subfields including the first AP channel subfield. An index associated with the first AP channel subfield corresponds to an index of the first AP in the multi-AP group indicated by the MID subfield.

In an embodiment, where the second frame is a PPDU, the PPDU further comprises an Ultra High Reliability (UHR) Short Training field (UHR-STF), a UHR Long Training field (UHR-LTF), and a UHR Signal field (UHR-SIG). In an embodiment, the UHR-STF precedes the UHR-SIG. In an embodiment, the preamble of the PPDU comprises the UHR-STF and the UHR-LTF.

In an embodiment, where the PPDU includes an MU PPDU for a first STA and a second STA, the UHR-SIG indicates a first RU for the first STA and a second RU for the second STA.

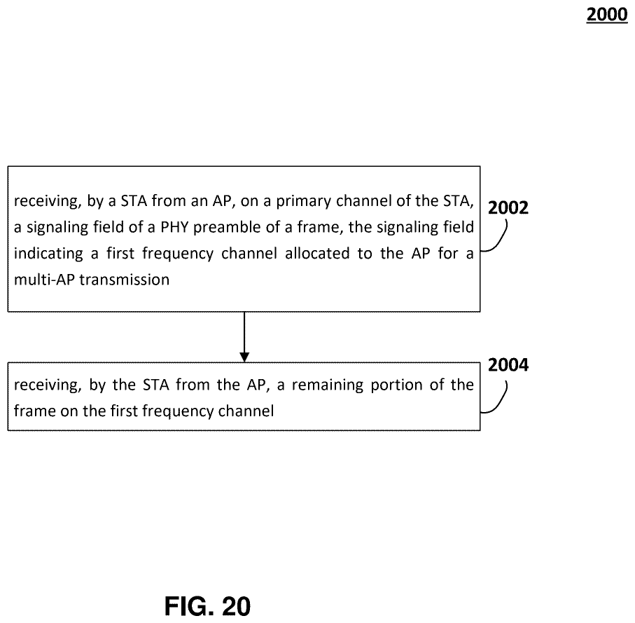

FIG. 20 illustrates an example process 2000 according to an embodiment. Example process 2000 is provided for the purpose of illustration only and is not limiting of embodiments. Process 2000 may be performed by a STA to receive a downlink frame transmission from an AP. The STA may be associated with the AP. The AP may be a member of a multi-AP group and the downlink frame transmission may be part of a multi-AP transmission within the multi-AP group. In an embodiment, the multi-AP transmission occurs during TXOP obtained by a second AP, e.g., a master AP of the multi-AP group. The multi-AP transmission may be a COFDMA transmission.

In step 2002, process 2000 includes receiving, by the STA from the AP, on a primary channel of the STA, a signaling field of a PHY preamble of a frame. In an embodiment, where the STA is associated with the AP, the primary channel of the STA corresponds to a primary channel of the AP. The primary channel of the AP corresponds to a default channel that the AP monitors for management frames or uses to transmit beacon frames. The frame may include a PPDU. The PPDU may an SU PPDU or an MU PPDU.

In an embodiment, the signaling field indicates a first frequency channel allocated to the AP for the multi-AP transmission. In an embodiment, the signaling field comprises a multi-AP frequency channel assignment for the multi-AP transmission including the first frequency channel allocated to the AP for the multi-AP transmission.

In an embodiment, the signaling field includes a Universal Signal field (U-SIG) or a UHR-SIG. The UHR-SIG may occur after the U-SIG. In an embodiment, the U-SIG or UHR-SIG comprises a multi-AP schedule announcement (MSA) subfield comprising the multi-AP frequency channel assignment for the multi-AP transmission. In an embodiment, the MSA subfield comprises a multi-AP identifier (MID) subfield indicating a multi-AP group of the AP. In an embodiment, the MSA subfield further comprises a first AP channel subfield indicating the first frequency channel allocated to the AP for the multi-AP transmission. In an embodiment, the MSA subfield comprises a plurality of AP channel subfields including the first AP channel subfield. An index associated with the first AP channel subfield corresponds to an index of the AP in the multi-AP group indicated by the MID subfield.

In step 2002, process 2000 includes receiving, by the STA from the AP, a remaining portion of the frame on the first frequency channel. In an embodiment, receiving the remaining portion of the frame on the first frequency channel comprises receiving a UHR-SIG.

In an embodiment, receiving the remaining portion of the frame on the first frequency channel comprises receiving a remaining portion of the PHY preamble on the first frequency channel. In an embodiment, receiving the remaining portion of the PHY preamble comprises receiving a UHR-STF and a UHR-LTF. In an embodiment, the UHR-STF precedes the UHR-SIG.

In an embodiment, process 2000 further includes determining a first RU for the STA from the UHR-SIG; and receiving a data field of the frame via the first RU.

In an embodiment, wherein the first frequency channel is different than the primary channel of the STA, process 2000 further comprises switching a receiver of the STA from the primary channel of the STA to the first frequency channel.

In an embodiment, where the first frequency channel is different than the primary channel of the STA, a portion of the preamble of the frame is transmitted by the AP on the primary channel of the STA in parallel with a transmission by the AP of the frame on the first frequency channel. In an embodiment, where the frame is a PPDU, the portion of the preamble of the second frame comprises a portion of a preamble of a PPDU. In an embodiment, the portion of the preamble of the PPDU comprises a U-SIG. In an embodiment, the portion of the preamble of the PPDU comprises: an L-STF, an L-LTF, an L-SIG, an RL-SIG, and a U-SIG.

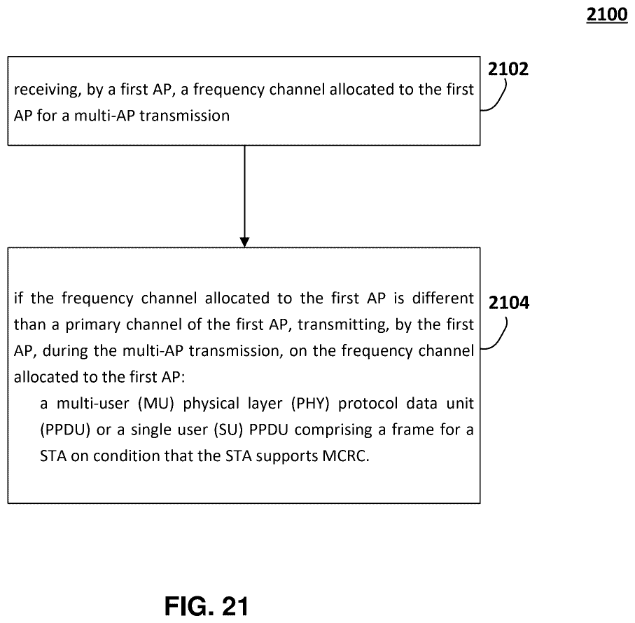

FIG. 21 illustrates an example process 2100 according to an embodiment. Example process 2100 is provided for the purpose of illustration only and is not limiting of embodiments. Process 2100 may be performed by a first AP. The first AP may be a member of a multi-AP group.

As shown in FIG. 21, process 2100 includes, in step 2102, receiving, by the first AP, a frequency channel allocated to the first AP for a multi-AP transmission. In an embodiment, the frequency channel allocated to the first AP is part of a multi-AP frequency channel assignment for the multi-AP transmission. The multi-AP transmission may be intended to occur during a TXOP obtained a second AP. The second AP may be a master AP of a multi-AP group that includes the first AP. The multi-AP transmission may be a COFDMA transmission, for example, including the first AP and a third AP, member of the multi-AP group.

In an embodiment, the frequency channel allocated to the first AP is received from the second AP. In an embodiment, the frequency channel allocated to the first AP may be received in an MSA frame. The MSA frame may include the multi-AP frequency channel assignment including the frequency channel allocated to the first AP.

In step 2104, process 2100 includes, if the frequency channel allocated to the first AP is different than a primary channel of the first AP, transmitting, by the first AP, during the multi-AP transmission, on the frequency channel allocated to the first AP: an MU PPDU or an SU PPDU for a STA, on condition that the STA supports MCRC. In an embodiment, the primary channel of the AP corresponds to a default channel that the AP monitors for management frames or uses to transmit beacon frames. In an embodiment, a STA supporting MCRC is capable of receiving on multiple frequency channels simultaneously.

In an embodiment, the STA is associated with the AP. In an embodiment, prior to step 2104, process 2100 may include receiving, by the AP from the STA, a frame indicating support of a multi-channel receive capability (MCRC) at the STA. In an embodiment, the frame may be an association request frame.

In an embodiment, process 2100 may further comprise broadcasting, by the first AP, the MSA frame on both the frequency channel allocated to the first AP and on the primary channel of the first AP. In an embodiment, broadcasting the MSA frame comprises broadcasting the MSA on condition that none of associated STAs support MCRC.

What is claimed is:

1. A first access point (AP) comprising:
one or more processors; and
memory storing instructions that, when executed by the one or more processors, cause the first AP to:
receive from a second AP a first frame comprising a multi-AP frequency channel assignment for a multi-AP transmission, the multi-AP frequency channel assignment comprising a first frequency channel allocated to the first AP for the multi-AP transmission;
transmit a second frame on the first frequency channel during the multi-AP transmission; and
on condition that the first frequency channel is different from a primary channel of the first AP, transmit a portion of a preamble of the second frame comprising the multi-AP frequency channel assignment on the primary channel of the first AP.

2. The first AP of claim 1, wherein transmitting the portion of the preamble of the second frame comprises transmitting the portion of the preamble of the second frame in parallel with transmitting the second frame.

3. The first AP of claim 1, wherein the portion of the preamble of the second frame comprises a Universal Signal field (U-SIG), and wherein the U-SIG comprises the multi-AP frequency channel assignment for the multi-AP transmission.

4. The first AP of claim 3, wherein the U-SIG comprises a multi-AP schedule announcement (MSA) subfield comprising the multi-AP frequency channel assignment for the multi-AP transmission, and wherein the MSA subfield further comprises a first AP channel subfield indicating the first frequency channel allocated to the first AP for the multi-AP transmission.

5. The first AP of claim 1, wherein the second frame comprises a UHR Signal field (UHR-SIG).

6. The first AP of claim 5, wherein the second frame includes a multi-user (MU) physical layer protocol data unit (PPDU) for a first station (STA) and a second STA, and wherein the UHR-SIG indicates a first resource unit (RU) for the first STA and a second RU for the second STA.

7. The first AP of claim 1, wherein the primary channel of the first AP corresponds to a default channel that the first AP monitors for management frames or uses to transmit beacon frames.

8. A station (STA) comprising:
one or more processors; and
memory storing instructions that, when executed by the one or more processors, cause the STA to:
receive from an access point (AP), on a primary channel of the STA, a signaling field of a physical layer (PHY) preamble of a frame, the signaling field indicating a first frequency channel allocated to the AP for a multi-AP transmission; and
receive from the AP a remaining portion of the frame on the first frequency channel.

9. The STA of claim 8, wherein the signaling field comprises a Universal Signal field (U-SIG), and wherein the U-SIG comprises a multi-AP frequency channel assignment for the multi-AP transmission.

10. The STA of claim 9, wherein the U-SIG comprises a multi-AP schedule announcement (MSA) subfield comprising the multi-AP frequency channel assignment for the multi-AP transmission, and wherein the MSA subfield further comprises a first AP channel subfield indicating the first frequency channel allocated to the AP for the multi-AP transmission.

11. The STA of claim 8, wherein the remaining portion of the frame comprises an Ultra High Reliability (UHR) Short Training field (UHR-STF) and a UHR Signal field (UHR-SIG).

12. The STA of claim 11, wherein the UHR-STF precedes the UHR-SIG.

13. The STA of claim 8, wherein the first frequency channel is different than the primary channel of the STA, and wherein the instructions, when executed by the one or more processors, further cause the STA to switch a receiver of the STA from the primary channel of the STA to the first frequency channel.

14. The STA of claim 8, wherein the STA is associated with the AP, and wherein the primary channel of the STA corresponds to a primary channel of the AP.

15. The STA of claim 14, wherein the primary channel of the AP corresponds to a default channel that the AP monitors for management frames or uses to transmit beacon frames.

16. A non-transitory computer-readable medium comprising instructions that, when executed by one or more processors of a first access point (AP), cause the first AP to:
receive from a second AP a first frame comprising a multi-AP frequency channel assignment for a multi-AP transmission, the multi-AP frequency channel assignment comprising a first frequency channel allocated to the first AP for the multi-AP transmission;
transmit a second frame on the first frequency channel during the multi-AP transmission; and
on condition that the first frequency channel is different from a primary channel of the first AP, transmit a portion of a preamble of the second frame comprising the multi-AP frequency channel assignment on the primary channel of the first AP.

17. The non-transitory computer-readable medium of claim 16, wherein transmitting the portion of the preamble of the second frame comprises transmitting the portion of the preamble of the second frame in parallel with transmitting the second frame.

18. The non-transitory computer-readable medium of claim 16, wherein the portion of the preamble of the second frame comprises a Universal Signal field (U-SIG), and wherein the U-SIG comprises the multi-AP frequency channel assignment for the multi-AP transmission.

19. The non-transitory computer-readable medium of claim 18, wherein the U-SIG comprises a multi-AP schedule announcement (MSA) subfield comprising the multi-AP frequency channel assignment for the multi-AP transmission, and wherein the MSA subfield further comprises a first AP channel subfield indicating the first frequency channel allocated to the first AP for the multi-AP transmission.

20. The non-transitory computer-readable medium of claim 16, wherein the second frame comprises:
a multi-user (MU) physical layer protocol data unit (PPDU) for a first station (STA) and a second STA; and
a UHR Signal field (UHR-SIG), wherein the UHR-SIG indicates a first resource unit (RU) for the first STA and a second RU for the second STA.
